(19) United States
(12) Patent Application Publication
(10) Pub. No.: US 2011/0200717 A1
(43) Pub. Date: Aug. 18, 2011

(54) PACKAGES AND METHODS OF PACKAGING FOOD PRODUCTS

(76) Inventor: Martin Lapham, Rye, NH (US)

(21) Appl. No.: 12/704,954

(22) Filed: Feb. 12, 2010

(51) Int. Cl. A21D 10/02; B31B 49/02

(52) U.S. Cl. 426/118; 426/395; 493/162; 493/55; 493/56

(57) ABSTRACT

A package for food products including a first portion, a second portion, and at least one indicator. The first portion has a first closed end, at least one first side wall surrounding the first closed end, and a first open end opposite the first closed end. The second portion has a second closed end, at least one second side wall surrounding said second closed end, and a second open end opposite the second closed end. The first portion and second portion are movably connected at their respective open ends. The at least one indicator is placed in communication with the package such that when the package is expanded to a desired inner volume the indicator is activated.

### FIELD OF THE INVENTION

In general, the invention relates to a packaging device for food products. More particularly, the invention relates to expandable packages for food products.

### BACKGROUND OF THE INVENTION

The art of food packaging is well developed. For example, within the art of dough packaging there are multiple ways of packaging proofed and un-proofed dough. Proofing dough is know in the art to mean allowing dough containing a leavening agent to rise for the proper amount of time such that the dough reaches a desired volume.

U.S. Pat. No. 6,635,291, Perry, entitled Leavened Dough or Batter Packaging System discloses a package for leavened dough designed to hold a desired internal equilibrium pressure.

U.S. Pat. No. 6,733,803, Vidkjaer, entitled Dough Containing, Valved Package discloses a package for dough that does not have to be proofed having a one-way venting valve to allow gas to escape from the package.

U.S. Pat. No. 1,861,124, Lorber, entitled Biscuit Package discloses a package for uncooked biscuits having a telescoping cover which provides space for the risen dough. Further, Lorber's design has a channel for receiving the telescoping cover and requires separation of a number of dough cakes with interposed circular disks which may complicate producing such a design.

U.S. Pat. No. 6,240,839, Amato, entitled Device for Proofing Dough discloses a mechanical device having an electronic alarm or electronic visual indicator assembly for signaling when the dough reaches a specific volume.

Most of the prior art mentioned above does not provide for packaging of un-proofed dough products. Known packages that do provide for packaging of un-proofed dough do not indicate when the dough is ready or proofed. Letting dough proof for the proper amount of time is an art. The time it takes dough to proof is dependent upon many variables such as temperature, humidity, dough ingredients and the strain of yeast used in the dough. Thus, the proof time of dough is often misjudged and the dough is used either prematurely or after it has proofed. Furthermore, known proofing approaches for dough generally require the consumer to purchase a separate device, apart from the dough packaging, to determine when the dough is ready. Such known prior art devices that indicate when dough is ready tend to be expensive and more suited for commercial operations.

### SUMMARY OF THE INVENTION

Embodiments of the invention relate to packages for food products. More specifically, embodiments of the invention relate to inexpensive expandable packages in which dough can be sold and in which dough can be proofed to the correct/desired volume by consumers.

In one embodiment of the present invention the package has two portions, a first portion and a second portion. The first portion has a first closed end, at least one first side wall surrounding the first closed end, and a first open end opposite the first closed end. The second portion has a second closed end, at least one second side wall surrounding said second closed end, and a second open end opposite the second closed end. The first portion and second portion are movably connected at their respective open ends, such that an enclosed void of variable volume is created between the first closed end and the second closed end. Additionally, at least one indicator is placed in communication with the package such that when the package is expanded to a desired inner volume the indicator is activated. Activation of the indicator may produce, for example, a visual indication, an audio indication, an indication recognizable by touch, or any combination thereof.

The packages of the present invention provide for an inexpensive and easily manufacturable package for food products. Furthermore, the packages of the present invention provide for a dough package in which dough can be manufactured, sold, and proofed to the correct or desired volume without the need for separate more expensive devices.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates an embodiment of an expandable package wherein the expandable package is expanded to show an indicator;

FIG. 2 illustrates an embodiment of an expandable package wherein the expandable package is fully collapsed;

FIG. 3 illustrates an embodiment of an expandable package wherein the expandable package portions are separated to show the interface portions;

FIG. 4 illustrates an embodiment of a method of making an expandable package;

FIG. 5 illustrates an embodiment of a pattern for making the portions of an expandable package;

FIG. 6 illustrates another embodiment of a pattern for making the portions of an expandable package; and

FIG. 7 illustrates an embodiment of a method of packaging a food product in an expandable package.

### DETAILED DESCRIPTION

Detailed embodiments of the present invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention.

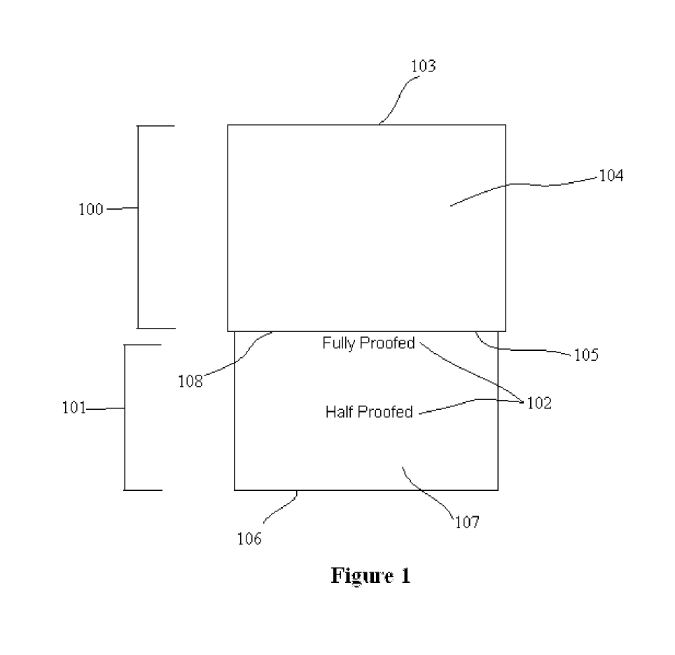

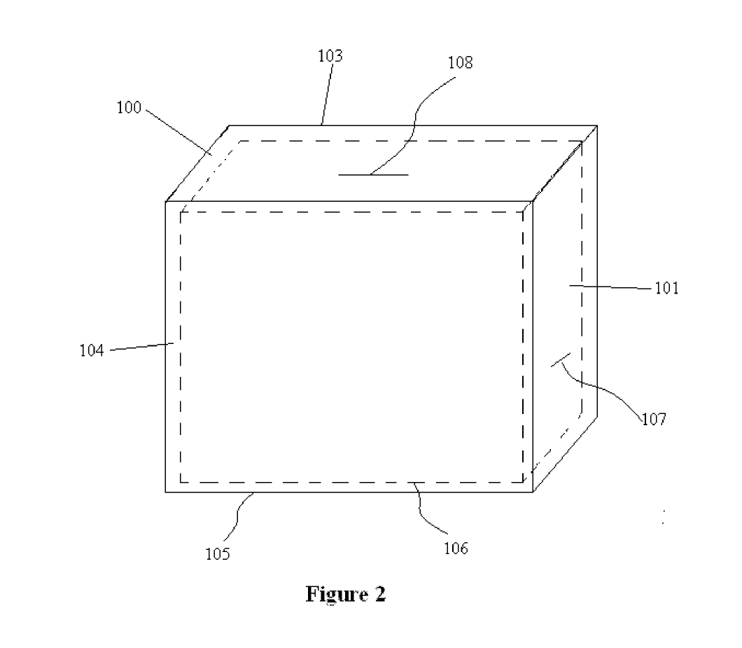

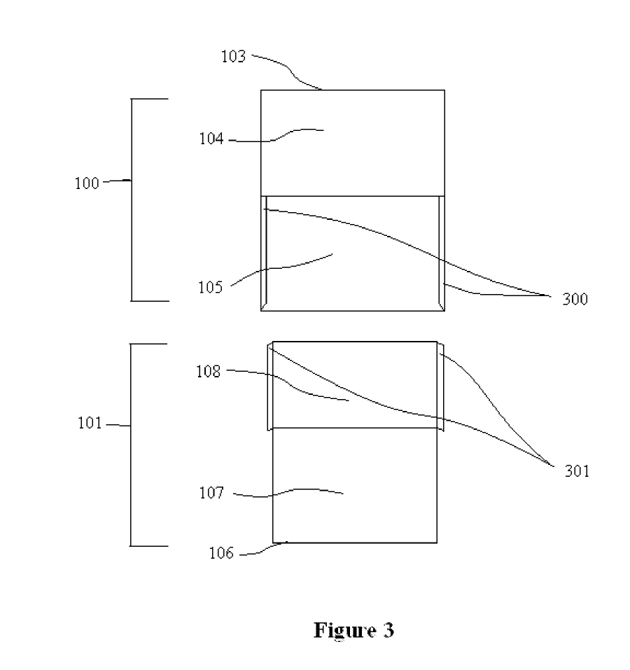

In general, aspects of the invention relate to packaging, and methods of making a package and packaging a food product. In one aspect, the invention relates to an expandable package for packaging food products. Referring first to FIGS. 1-3, wherein FIG. 1 depicts an expanded package with a square/rectangular cross section, FIG. 2 depicts a collapsed package with a square/rectangular cross section, and FIG. 3 depicts a package having a square/rectangular cross section with the package portions separated from one another. One embodiment of the package includes a first portion 100, a second portion 101, and at least one indicator 102.

The first portion 100 has a first closed end 103, at least one first side wall 104 surrounding the first closed end 103, and a first open end 105 opposite the first closed end 103. The second portion 101 has a second closed end 106, at least one second side wall 107 surrounding the second closed end 106, and a second open end 108 opposite the second closed end 106. The first portion 100 and second portion 101 are movably connected at their respective open ends 105 and 108 such that an enclosed void of variable volume is created between the first closed end 103 and the second closed end 106.

The at least one indicator 102 is placed in communication with the package such that when the package is expanded to a desired inner volume the indicator 102 is activated. As shown in FIG. 1, activation of the indicator 102 produces a visual indication that may read “Half Proofed,” or “Fully Proofed” depending on the inner volume of the package. Although, only printed words are shown in FIG. 1, it is contemplated that any number of any words, descriptions, phrases, symbols, pictures, combinations thereof, or other visual indication means may be used. It is further contemplated that activation of the indicator may produce, for example, a visual indication, an audio indication, an indication recognizable by touch, or any combination thereof.

In other embodiments, the indicator 102 is activated when the inner volume of the package reaches a volume in the range of about 90 to 94 cubic inches, and/or when the inner volume of the package reaches a volume in the range of about 108 to 112 cubic inches.

As shown in FIGS. 1-3, the package is depicted as having a square/rectangular cross section. However, in other embodiments of the package any cross sectional shape may be used, for example, a cross section that is circular, square, rectangular, octagonal, triangular, hexagonal, pentagonal, or any combination thereof.

Another embodiment of the package, as shown in FIG. 3, includes at least one first interface portion 300 at the first open end 105 of the first portion 100, and at least one second interface portion 301 at the second open end 108 of the second portion 101. These interface portions 300 and 301 engage with each other when the first and second portions 100 and 101 are connected and allow the package to expand and contract in volume as the first and/or second portion(s) 100 and 101 is moved. The purpose of the interface portions 300 and 301 is to prevent the package from expanding to far and separating the first and second portions 100 and 101 apart. As shown in FIG. 3, the interface portions are depicted as tabs folded inward on the first portion 100 and outward on the second portion 101. However, it is contemplated that any means of preventing the two portions 100 and 101 from separating apart when the package is expanded may be used.

Further embodiments of the package may include one or more of the following features. The first portion 100 wherein the first closed end 103 is capable of being opened such that the food product packed within can be removed. As shown in FIGS. 1-3, the package is shown as expanding vertically. However, in other embodiments of the package any configuration may be used, for example, the package may expand vertically, horizontally, or on an angle. Furthermore, FIGS. 1 and 2 depict the package as having a second portion 101 which is smaller that the first portion 100 such that the second portion 101 fits within the first portion 100. However, in other embodiments of the package the first portion 100 is smaller than the second portion 101 and is placed within the second portion 101.

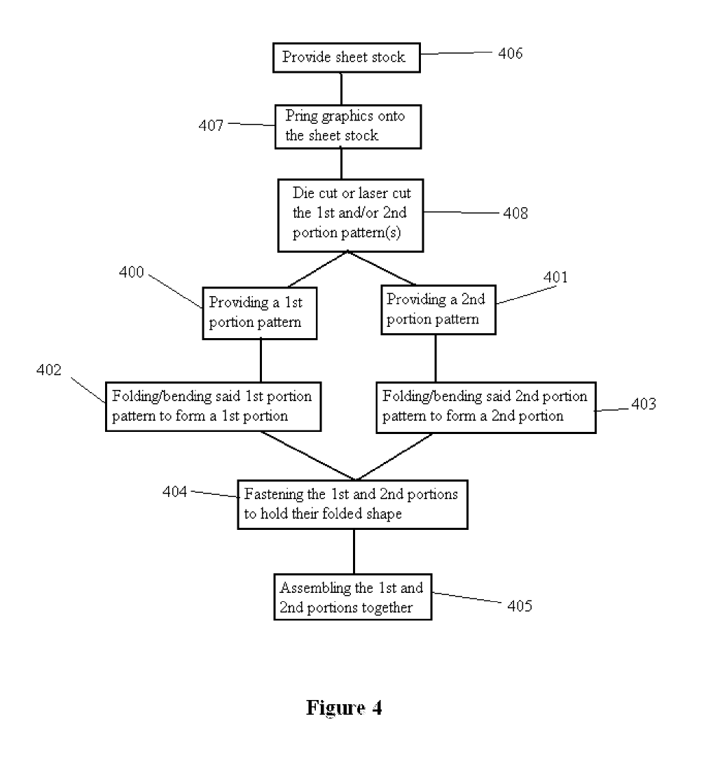

In another aspect, the invention relates to a method of making an expandable package. Referring to FIG. 4, one embodiment of the method for making a package includes providing a first portion pattern 400, providing a second portion pattern 401, bending or folding the first portion pattern 402, bending or folding the second portion pattern 403, fastening the first portion such that the first portion retains the folded configuration 404 and fastening the second portion such that the second portion retains the folded configuration 404, and assembling the first portion and the second portion 405.

More specifically, bending or folding the first portion 402 includes folding the first portion pattern to form a first portion having a first closed end, at least one first side wall surrounding the first closed end, a first open end opposite the first closed end, and at least one first interface portion at the first open end. Bending or folding the second portion 403 includes folding the second portion pattern to form a second portion having a second closed end, at least one second side wall surrounding the second closed end, a second open end opposite the second closed end, and at least one second interface portion at the second open end.

The fastening step 404 includes securing the bended or folded patterns with any adhesive material to maintain their bended or folded configurations of the first and second portions. Furthermore, assembling the first portion and the second portion 405 includes assembling the first and second portions such that the first interface portion of the first portion engages with the second interface portion of the second portion, and thus producing a package in which the first and second portions are movably attached to each other at their respective open ends.

Other embodiments of the method for making a package, may include one or more of the following steps. providing sheet stock for printing onto 406; printing graphics or other designs onto a sheet stock 407; and die cutting or laser cutting the patterns for the first and second portions out of a printed or un-printed sheet stock 408.

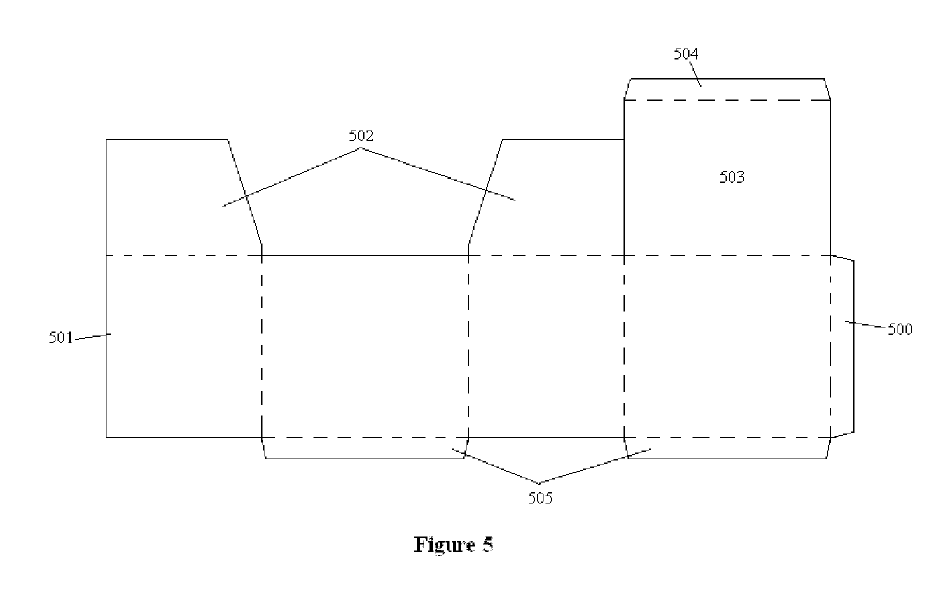

One example of a pattern for producing the first and/or second portions is shown in FIG. 5, wherein the dashed lines represent folds or bends. Bending/folding and fastening the pattern depicted in FIG. 5 into a first and/or second portion includes the following, not necessarily in the following order: fastening tab 500 to edge 501, folding the two tabs 502 toward the center, folding end 503 over the two tabs 502, inserting tab 504 into the enclosure, and folding the interface tabs 505 in the desired direction depending on which portion is being folded, as mentioned above.

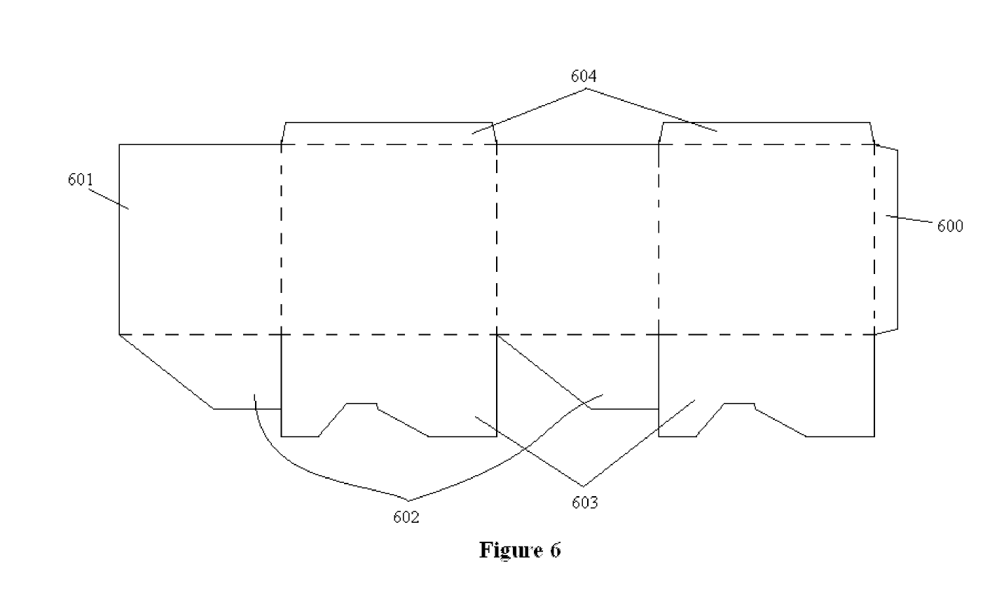

Another example of a pattern for producing the first and/or second portions is shown in FIG. 6, wherein the dashed lines represent folds or bends. Bending/folding and fastening the pattern depicted in FIG. 6 into a first and/or second portion includes the following, not necessarily in the following order: fastening tab 600 to edge 601, folding the two tabs 602 toward the center, folding and interlocking the two end tabs 603 together over the two tabs 602 and fastening, and folding the interface tabs 604 in the desired direction depending on which portion is being folded, as mentioned above.

FIGS. 5 and 6 depict the pattern as producing a first and/or second portion having a square/rectangular cross section. However, in other embodiments of the pattern may produce a first and/or second portion having any cross sectional shape may be used, for example, a cross section that is circular, square, rectangular, octagonal, triangular, hexagonal, pentagonal, or any combination thereof. Although FIGS. 5 and 6 only provide two examples it is contemplated that other patterns could be used to create embodiments of the invention.

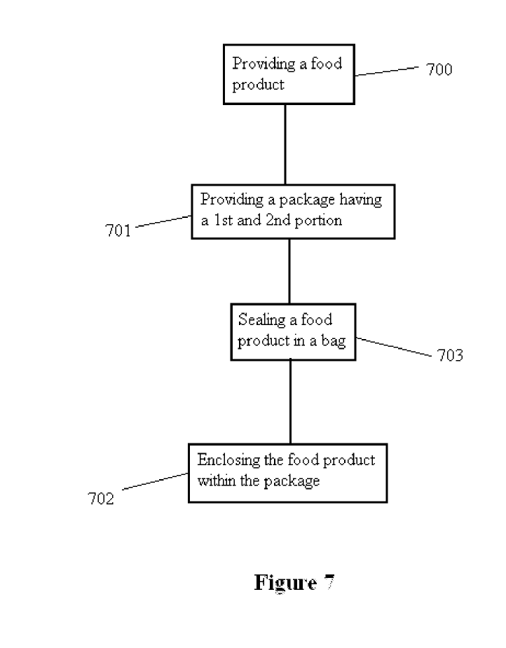

In another aspect, the invention relates to a method for packaging a food product. Referring to FIG. 7, one embodiment of the method of packaging includes providing a food product 700, providing a package 701, and enclosing the food product within the package 702. Providing a food product 700 may further include providing a food product such as dough or popcorn. Enclosing the food product within the package 702 may further include placing the food product inside the package and closing the package.

Furthermore, providing a package 701 includes providing a package, having a first portion, a second portion, and at least one indicator. The first portion has a first closed end, at least one first side wall surrounding the first closed end, and a first open end opposite the first closed end. The second portion has a second closed end, at least one second side wall surrounding said second closed end, and a second open end opposite the second closed end. The first portion and second portion are movably connected at their respective open ends. The at least one indicator is placed in communication with the package such that when the package is expanded to a desired inner volume the indicator is activated.

Another embodiment of the method of packaging further includes providing a package having interface portions, which prevent the package from expanding to far and separating the first and second portions apart. Providing a package with interface portions includes providing a first portion with at least one first interface portion at the first open end of the first portion and a second portion with at least one second interface portion at the second open end of the second portion.

Another embodiment of the method of packaging includes the step of sealing the food product in a bag 703. Sealing the food product in bag, within the package, prevents the food product from becoming contaminated during the storage, transportation, and manufacturing of the packaged food product. Furthermore, the food product can be sealed in a plastic bag, a thermoplastic bag, a foil or metallic bag, a paper bag, a bag having the desired barrier properties such as moisture or gas barrier properties, any other contamination preventing covering, or any combination thereof. Optionally, the step of sealing the food product in a bag 703 may further include sealing the food product in a bag having a large enough volume to expand the packaging enough to activate an indicator, allowing the food product to expand within the bag and reach the desired volume.

While the invention has been described and illustrated in connection with preferred embodiments, many variations and modifications will be evident to those skilled in the art and may be made without departing from the spirit and scope of the invention. The invention is thus not to be limited to the precise details of methodology or construction set forth above as such variations and modification are intended to be included within the scope of the invention.

What is claimed is:

1. A package for food products comprising:
a first portion having a first closed end, at least one first side wall surrounding said first closed end, and a first open end opposite said first closed end;
a second portion having a second closed end, at least one second side wall surrounding said second closed end, and a second open end opposite said second closed end; said second open end of said second portion being movably attached to said first open end of said first portion; and
at least one indicator in communication with said package such that when said package is expanded to a desired inner volume said indicator is activated.

2. The package of claim 1, further comprising at least one first interface portion at said first open end and at least one second interface portion at said second open end, wherein said first interface portion engages with said second interface portion.

3. The package of claim 1, wherein said first closed end of said first portion is openable.

4. The package of claim 1, wherein said indicator is activated when said inner volume of said package is in the range of about 108 to 112 cubic inches.

5. The package of claim 1, wherein said indicator is activated when said inner volume of said package is in the range of about 90 to 94 cubic inches.

6. The package of claim 1, wherein said second portion is smaller than said first portion such that said second portion fits inside of said first portion.

7. The package of claim 1, wherein said first portion is smaller than said second portion such that said first portion fits inside of said second portion.

8. A method of making a package comprising the steps of:
providing a first portion pattern;
providing a second portion pattern;
folding said first portion pattern to form a first portion having a first closed end, at least one first side wall surrounding said first closed end, a first open end opposite said first closed end, and at least one first interface portion at said first open end;
folding said second portion pattern to form a second portion having a second closed end, at least one second side wall surrounding said second closed end, a second open end opposite said second closed end, and at least one second interface portion at said second open end;
fastening said first portion such that said first portion retains the folded configuration;
fastening said second portion such that said second portion retains the folded configuration; and
assembling said first portion and said second portion such that said first interface portion of said first portion engages with said second interface portion of said second portion and said first portion and said second portion are movably attached.

9. The method of claim 8, further comprising the step of providing a sheet stock.

10. The method of claim 9, further comprising the step of printing said sheet stock.

11. The method of claim 8, further comprising the step of cutting a first portion pattern.

12. The method of claim 8, further comprising the step of cutting a second portion pattern.

13. A method of packaging a food product comprising the steps of:
providing a food product;
providing a package comprising:
a first portion having a first closed end, at least one first side wall surrounding said first closed end, and a first open end opposite said first closed end;
a second portion having a second closed end, at least one second side wall surrounding said second closed end, and a second open end opposite said second closed end; said second open end of said second portion being movably attached to said first open end of said first portion; and
at least one indicator in communication with said package such that when said package is expanded to a desired inner volume said indicator is activated; and
enclosing said food product within said package.

14. The method of claim 13, further comprising the step of sealing said food product in a bag.

15. The method of claim 14, wherein said bag is a plastic bag.

16. The method of claim 14, wherein said bag is a thermoplastic bag.

17. The method of claim 13, wherein said step of providing said package further includes providing a first portion having at least one first interface portion at said first open end and a second portion having at least one second interface portion at said second open end.

18. The method of claim 14, wherein said bag is large enough such that said bag is capable expanding said package to activate said indicator.
